(19) United States
(12) Patent Application Publication
(10) Pub. No.: US 2025/0187954 A1
(43) Pub. Date: Jun. 12, 2025

(54) SALT CELL SYSTEM WITH SHIELD BODY ASSEMBLY AND RELATED METHODS

(71) Applicant: BENJAMIN ESCUDERO, ORLANDO, FL (US)

(72) Inventor: BENJAMIN ESCUDERO, ORLANDO, FL (US)

(21) Appl. No.: 18/976,746

(22) Filed: Dec. 11, 2024

Related U.S. Application Data
(60) Provisional application No. 63/609,041, filed on Dec. 12, 2023.

(51) Int. Cl. C02F 1/68; C02F 103/02

(52) U.S. Cl. CPC C02F 1/687; C02F 2103/02

(57) ABSTRACT

A salt cell system for a pool circulation system includes a salt cell coupled with the pool circulation system. The salt cell system also includes a shield body assembly coupled to the salt cell. The shield body assembly also includes shield support arms coupled to the pool circulation system adjacent to the salt cell, and a curved shield coupled to the shield support arms opposite the salt cell.

### RELATED APPLICATION

This application is based upon prior filed copending Application No. 63/609,041 filed Dec. 12, 2023, the entire subject matter of which is incorporated herein by reference in its entirety.

### TECHNICAL FIELD

The present disclosure relates to the field of pool equipment accessories, and, more particularly, to a shield for a salt cell and related methods.

### BACKGROUND

Pools are quite common in both residential and commercial markets within the United States. A critical system for every pool is the chlorination system, which is responsible for the sanitation of the pool water. Currently, the two most common approaches to chlorination are the free chlorine method and the salt cell method. In the salt cell method, dissolved salt is used for the chlorination of water. The chlorine generator (i.e., the salt cell, salt generator, salt chlorinator, or SWG) uses electrolysis in the presence of dissolved salt to produce chlorine gas or its dissolved forms, hypochlorous acid and sodium hypochlorite, which are already commonly used as sanitizing agents in pools.

### SUMMARY

Generally, a salt cell system for a pool circulation system includes a salt cell coupled with the pool circulation system. The salt cell system also includes a shield body assembly coupled to the pool circulation system adjacent to the salt cell. The shield body assembly also includes a plurality of shield support arms coupled to the salt cell, and a curved shield coupled to the plurality of shield support arms opposite the salt cell.

In particular, each shield support arm may comprise a clamp configured to attach to the salt cell, and a connector coupled between the clamp and the curved shield. Each shield support arm may comprise a fastener coupling the clamp to the connector. The connector may comprise first and second arms extending laterally and oppositely therefrom, and the curved shield may define a slotted recess to receive the first and second arms. The clamp may comprise an O-clamp comprising first and second clamp arms, and a hinge coupling the first and second clamp arms at a first end. Each of the first and second clamp arms may define a distal opening at a second end opposite to the first end, the distal opening receiving a fastener. The connector may define a longitudinal slot.

For example, the curved shield may have a semi-cylinder shape. In some embodiments, the curved shield may comprise an ultraviolet radiation absorbing material. In other embodiments, the curved shield may comprise a body, and a reflective underlayer carried by the body.

Another aspect is directed to a shield body assembly for a salt cell in a salt cell system for a pool circulation system. The shield body assembly comprises a plurality of shield support arms to be coupled to the pool circulation system adjacent to the salt cell, and a curved shield coupled to the plurality of shield support arms opposite the salt cell.

Yet another aspect is directed to a method for making a shield body assembly for a salt cell in a salt cell system for a pool circulation system. The method comprises coupling a plurality of shield support arms to be coupled to the pool circulation system adjacent to the salt cell, and forming a curved shield to be coupled to the plurality of shield support arms opposite the salt cell.

### BRIEF DESCRIPTION OF THE DRAWINGS

FIG. 1 is a side view of a pool system, according to a first embodiment of the present disclosure.

FIG. 2 is a front view of a salt cell system from the pool system of FIG. 1 in a disconnected state.

FIG. 3 is a side view of the salt cell system from the pool system of FIG. 1 in the disconnected state.

FIG. 4 is a bottom side view of the salt cell system from the pool system of FIG. 1 in the disconnected state.

FIG. 5 is a perspective view of a salt cell system, according to a second embodiment of the present disclosure.

FIG. 6 is a side view of the salt cell system of FIG. 5.

FIG. 7 is an exploded view image of a shield body assembly of FIG. 5.

FIG. 8 is a perspective view of the connector from the shield body assembly of FIGS. 5-7.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

In typical salt cell systems, the salt cell is exposed to an outdoor environment. In other words, the salt cell is exposed to the elements, for example, sunlight/UV rays, extreme temperature fluctuations, substandard salt cell maintenance, harmful pool water chemistry, heavy scale build-up on the internal salt cell electrodes, inconsistent electrical flow (electricity), heavy swimming pool bather load, and the like. Over time, the salt cell may be degraded from this exposure, which may significantly reduce the lifetime of the salt cell. Due to the cost of the salt cell, this may be problematic. The present disclosure provides an approach to this problem.

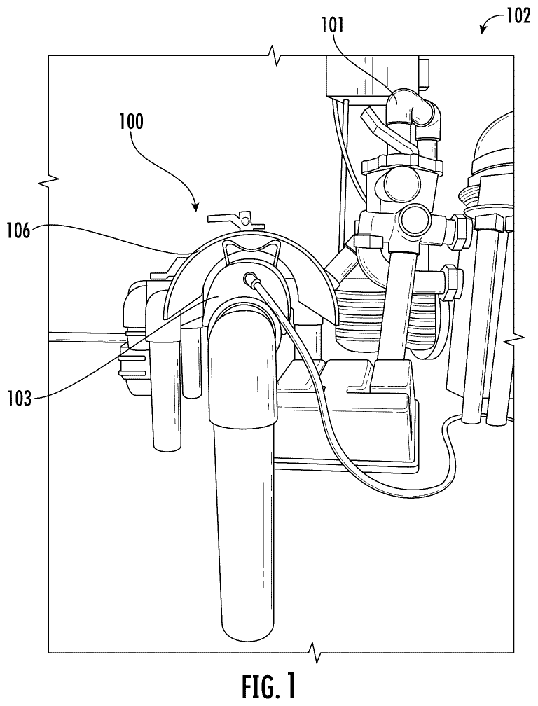

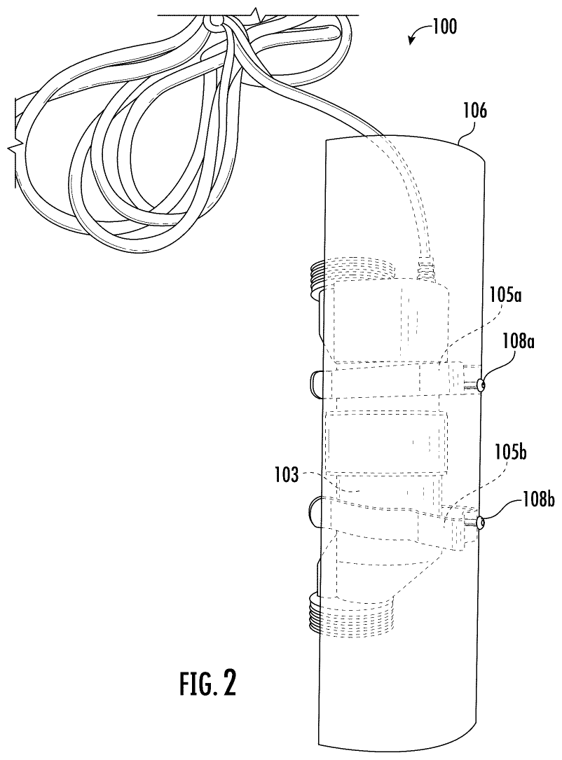

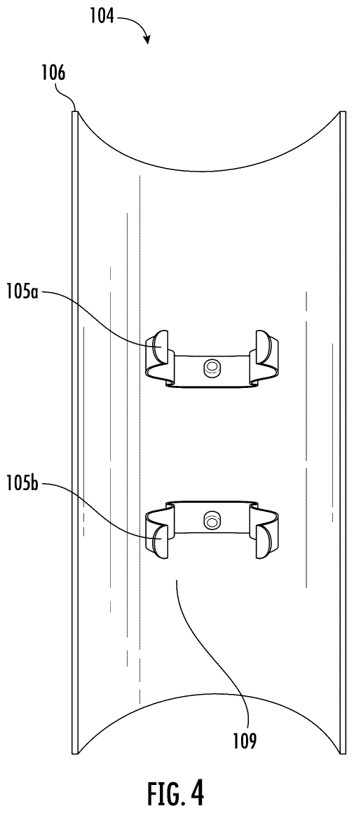

Referring initially to FIGS. 1-4, a salt cell system 100 according to the present disclosure is now described. As will be appreciated, the salt cell system 100 is for a pool circulation system 101 of a pool system 102. In particular, the pool circulation system 101 comprises a pump and filter arrangement configured to receive water from a pool, and output filtered water to the salt cell system 100, which is then fed back into the pool. The salt cell system 100 comprises a salt cell 103 coupled with the pool circulation system 101, and a shield body assembly 104 coupled to the salt cell. The shield body assembly 104 includes a plurality of support arm pairs 105a-105b coupled to the salt cell 103, a curved shield 106 coupled to the plurality of support arm pairs opposite the salt cell, and a plurality of fasteners 108a-108b (e.g., threaded screws with threaded nuts) coupling the curved shield to the plurality of support arm pairs.

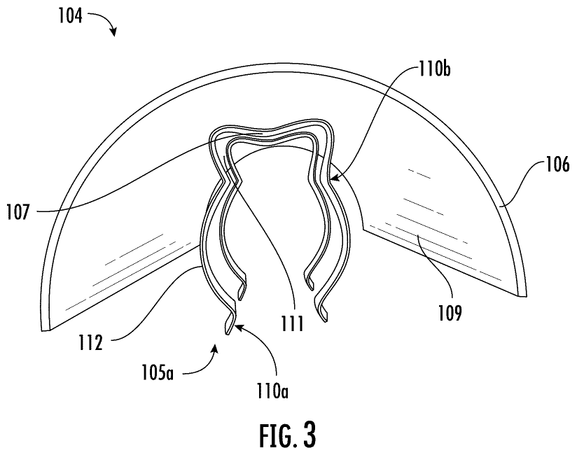

As perhaps best seen in FIG. 3, the curved shield 106 illustratively has a semi-cylinder shape. In other embodiments, the curved shield 106 may comprise a more oblong shape or a flat shape. In yet other embodiments, the curved shield 106 may have a non-curved shape, such as a V-shaped cross-section approximating a gable roof arrangement. The curved shield 106 may include an ultraviolet (UV) radiation absorbing material. For example, the UV radiation absorbing material may comprise polycarbonate material that absorbs/blocks UVA-UVB radiation (i.e., being opaque to UV radiation). In the illustrated embodiment, the curved shield 106 comprises a body, and a reflective underlayer 109 coupled to the body. The reflective underlayer 109 may comprise a reflective sheet with an adhesive backing to be pressed into the body, such as a reflective mylar sheet. In some embodiments, the reflective underlayer 109 may be replaced with an undercoating or overcoating on the body, for example, a reflective metallic coating (metallic mirror coating). The reflective underlayer 109 may be used with a non-UV blocking body or in combination with a UV block body.

Each of the plurality of support arm pairs 105a-105b comprises a flexible material for surrounding and retaining the salt cell 103. For example, the flexible material may comprise a metallic material, such as aluminum or various plastics. Each of the support arm pairs 105a-105b comprises a medial portion 107 coupled to the curved shield 106 via the plurality of fasteners 108a-108b, and opposing cell arms 110a-110b with curved features extending from the medial portion. Each cell arm 110a-110b illustratively comprises a proximal bend portion 111 coupled to the medial portion, and a distal retention portion 112 extending from the proximal bend portion to abut and retain the salt cell 103. The proximal bend portion 111 is shaped to deform and flex yet resist deformation to cause the distal retention portion 112 to press against and abut the salt cell 103.

As will be appreciated, in typical applications, the salt cell 103 is coupled to the pool circulation system 101 via an inline junction to the fluid output. For example, the salt cell 103 is coupled inline via threaded collars, which mate with opposing threaded ends of the salt cell. In some embodiments, the support arm pairs 105a-105b may couple to the threaded collars. Further, in some embodiments, the plurality of support arm pairs 105a-105b may travel longitudinally to allow the shield body assembly 104 to fit salt cells of varying length (e.g., via a rail arrangement).

Another aspect is directed to a method for making a salt cell system 100 for a pool circulation system 101. The method also includes forming a curved shield 106, and coupling a plurality of support arm pairs 105a-105b between a salt cell 103 and the curved shield.

Helpfully, the shield body assembly 104 provides protection for the salt cell 103 from the elements and more particularly from the sunlight. This may extend the lifetime of the salt cell 103.

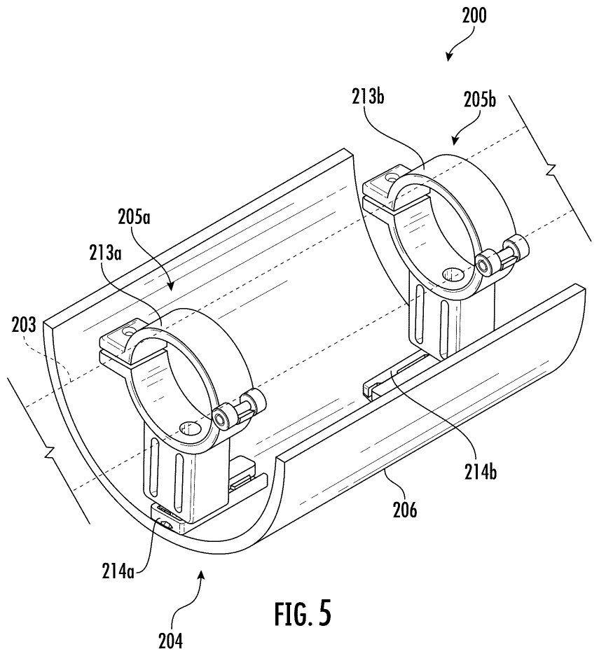

Referring now to FIGS. 5-8, another embodiment of the salt cell system 200 is now described. In this embodiment of the salt cell system 200, those elements already discussed above with respect to FIGS. 1-4 are incremented by 100 and most require no further discussion herein. This salt cell system 200 is for a pool circulation system (not shown) comprising a salt cell 203 coupled with the pool circulation system. The salt cell system 200 also includes a shield body assembly 204 coupled to the salt cell 203 and comprising a plurality of shield support arms 205a-205b coupled to the pool circulation system adjacent to the salt cell, and a curved shield 206 coupled to the plurality of shield support arms opposite the salt cell.

In some embodiments, the salt cell 203 is coupled to the pool circulation system via a pair of quick release unions (e.g., threaded sleaves). The plurality of shield support arms 205a-205b may be coupled to the pair of quick release unions rather than directly on the salt cell 203, which can be undesirable (e.g., voiding warranty and related service to the salt cell). Of course, in other embodiments, the plurality of shield support arms 205a-205b may be coupled to adjacent piping leading to and from the salt cell 203 or the salt cell directly.

For example, the curved shield 206 illustratively includes has a semi-cylinder shape. In some embodiments, the curved shield 206 may comprise an ultraviolet radiation absorbing material. In other embodiments, the curved shield 206 may comprise a body, and a reflective underlayer carried by the body.

Each shield support arm 205a-205b illustratively includes a clamp 213a-213b configured to attach to the salt cell 203, a medial post 209 extending from the clamp, and a connector 214a-241b coupled between the medial post and the curved shield 206. The clamp 213a-213b and medial post 209 may each comprise a rigid and durable material, such as plastic, metal, or a combination thereof. Each shield support arm 205a-205b comprises a fastener 215a-215b (e.g., threaded screw) coupling the clamp 213a-213b to the connector 214a-214b.

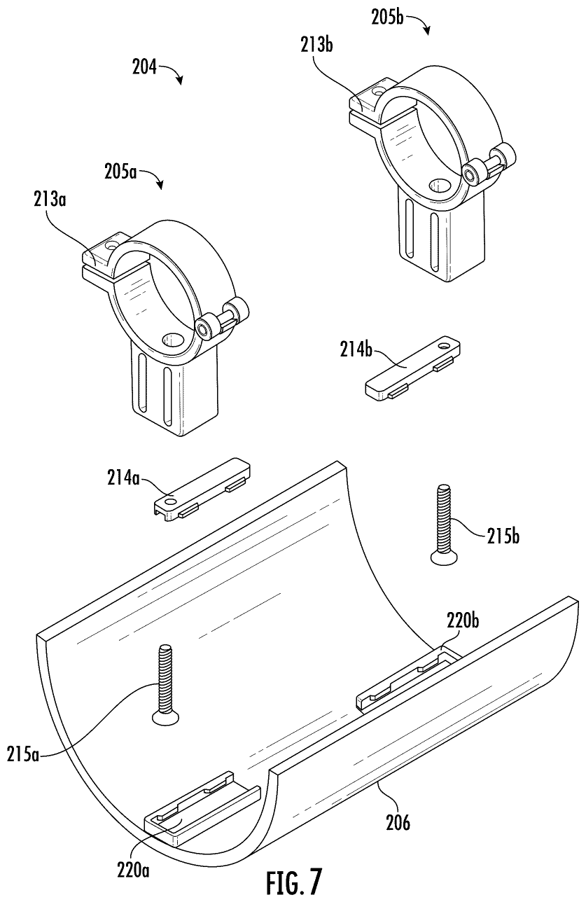

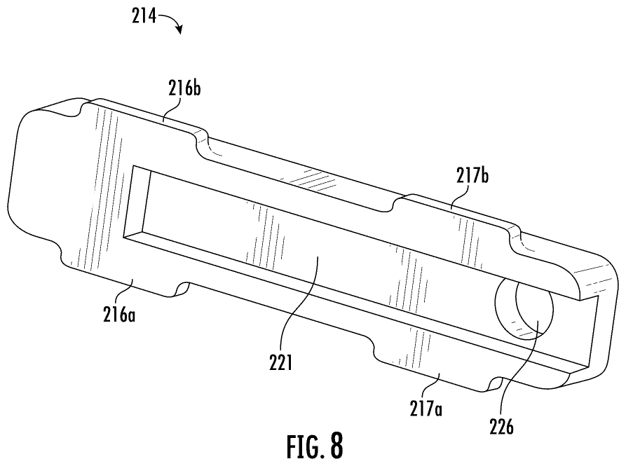

As perhaps best seen in FIGS. 7-8, the connector 214a-214b comprises first and second arm pairs 216a-216b, 217a-217b extending laterally and oppositely therefrom. The curved shield 206 defines a slotted recess 220a-220b to receive the first and second arms pairs 216a-216b, 217a-217b, thereby defining a tongue and groove coupling interface. The connector 214a-214b defines a longitudinal slot 221.

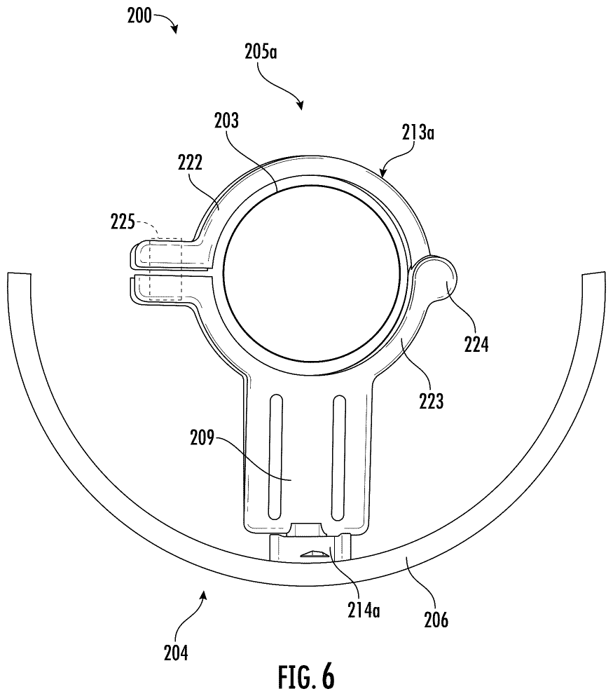

As perhaps best seen in FIG. 6, the clamp 213a-213b illustratively comprises a closeable O-clamp comprising first and second clamp arms 222-223, and a hinge 224 coupling the first and second clamp arms at a first end. Each of the first and second clamp arms 222-223 defines a distal opening 225 at a second end opposite to the first end, the distal opening receiving a fastener (e.g., threaded screw or snap fastener, not shown). This may allow for a tight fit on the quick release unions, for example, thereby preventing undesired rotation of the shield body assembly 204. Further, each connector 214a-214b illustratively includes a fastener receiving opening 226 for respectively receiving the fasteners 215a-215b.

As will be appreciated, this may allow for an easy install process for the shield body assembly 204. First, the user needs to couple the plurality of shield support arms 205a-205b to the curved shield 206. This requires coupling the clamp 213a-213b to the connector 214a-214b, and then coupling the connector to the curved shield 206. Then, the user would open the closeable O-clamp and fit it over adjacent piping surrounding the salt cell 203, and then close and lock the closeable O-clamp using the fastener.

Yet another aspect is directed to a method for making a shield body assembly 204 for a salt cell 203 in a salt cell system 200 for a pool circulation system. The method comprises coupling a plurality of shield support arms 205a-205b to be coupled to the salt cell 203, and forming a curved shield 206 to be coupled to the plurality of shield support arms opposite the salt cell.

It should be appreciated that some or all of the features of the disclosed embodiments of the salt cell system 100, 200 may be combined with each other. Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A salt cell system for a pool circulation system, the salt cell system comprising:
a salt cell coupled with the pool circulation system; and
a shield body assembly coupled to the pool circulation system adjacent to the salt cell and comprising a plurality of shield support arms coupled to the salt cell, and a curved shield coupled to the plurality of shield support arms opposite the salt cell.

2. The salt cell system of claim 1 wherein each shield support arm comprises a clamp configured to attach to the salt cell, and a connector coupled between the clamp and the curved shield.

3. The salt cell system of claim 2 wherein each shield support arm comprises a fastener coupling the clamp to the connector.

4. The salt cell system of claim 2 wherein the connector comprises first and second arms extending laterally and oppositely therefrom; and wherein the curved shield defines a slotted recess to receive the first and second arms.

5. The salt cell system of claim 2 wherein the clamp comprises an O-clamp comprising first and second clamp arms, and a hinge coupling the first and second clamp arms at a first end; and wherein each of the first and second clamp arms defines a distal opening at a second end opposite to the first end, the distal opening receiving a fastener.

6. The salt cell system of claim 2 wherein the connector defines a longitudinal slot.

7. The salt cell system of claim 1 wherein the curved shield has a semi-cylinder shape.

8. The salt cell system of claim 1 wherein the curved shield comprises an ultraviolet radiation absorbing material.

9. The salt cell system of claim 1 wherein the curved shield comprises a body, and a reflective underlayer carried by the body.

10. A shield body assembly for a salt cell in a salt cell system for a pool circulation system, the shield body assembly comprising:
a plurality of shield support arms to be coupled to the pool circulation system adjacent to the salt cell; and
a curved shield coupled to the plurality of shield support arms opposite the salt cell.

11. The shield body assembly of claim 10 wherein each shield support arm comprises a clamp configured to be attached to the salt cell, and a connector coupled between the clamp and the curved shield.

12. The shield body assembly of claim 11 wherein each shield support arm comprises a fastener coupling the clamp to the connector.

13. The shield body assembly of claim 11 wherein the connector comprises first and second arms extending laterally and oppositely therefrom; and wherein the curved shield defines a slotted recess to receive the first and second arms.

14. The shield body assembly of claim 11 wherein the clamp comprises an O-clamp comprising first and second clamp arms, and a hinge coupling the first and second clamp arms at a first end; and wherein each of the first and second clamp arms defines a distal opening at a second end opposite to the first end, the distal opening receiving a fastener.

15. The shield body assembly of claim 11 wherein the connector defines a longitudinal slot.

16. The shield body assembly of claim 10 wherein the curved shield has a semi-cylinder shape; and wherein the curved shield comprises an ultraviolet radiation absorbing material.

17. The shield body assembly of claim 10 wherein the curved shield comprises a body, and a reflective underlayer carried by the body.

18. A method for making a shield body assembly for a salt cell in a salt cell system for a pool circulation system, the method comprising:
coupling a plurality of shield support arms to be coupled to the pool circulation system adjacent to the salt cell; and
forming a curved shield to be coupled to the plurality of shield support arms opposite the salt cell.

19. The method of claim 18 wherein each shield support arm comprises a clamp configured to be attached to the salt cell, and a connector coupled between the clamp and the curved shield.

20. The method of claim 19 wherein each shield support arm comprises a fastener coupling the clamp to the connector; wherein the connector comprises first and second arms extending laterally and oppositely therefrom; and wherein the curved shield defines a slotted recess to receive the first and second arms.
